(19) United States
(12) Patent Application Publication
(10) Pub. No.: US 2022/0301215 A1
(43) Pub. Date: Sep. 22, 2022

(54) SYSTEMS AND METHODS FOR ONBOARD DIMENSIONING

(71) Applicant: Illinois Tool Works Inc., Glenview, IL (US)

(72) Inventors: Kevin Detert, Fairmont, MN (US); Jacob Green, Fairmont, MN (US); Andrew Sukalski, Fairmont, MN (US); Benjamin Whittier, St. Peter, MN (US); Aaron Packer, Mankato, MN (US)

(21) Appl. No.: 17/689,214

(22) Filed: Mar. 8, 2022

Related U.S. Application Data
(60) Provisional application No. 63/161,602, filed on Mar. 16, 2021.

(51) Int. Cl. G06T 7/62; G06T 7/70

(52) U.S. Cl. CPC G06T 7/62; G06T 7/70; G06T 2207/10044; G06T 2207/10028; G06T 2207/30248

(57) ABSTRACT

The present disclosure provides an onboard object dimensioning system for a vehicle, such as a lift truck. The vehicle may have one or more sensors (e.g., a radar system, an acoustic sensor, an image capture system, LIDAR, microwave, etc.) to generate and transmit a signal toward an object on the vehicle, which is received as a feedback signal corresponding to a reflection from one or more surfaces of the object. Control circuitry receives data from the sensors including signal characteristics of the feedback signal. The data is converted into multiple dimensions corresponding to the one or more surfaces of the object, which are employed to determine a shape, volume, orientation, or area of the one or more surfaces of the object corresponding to the first and second dimensions.

### CROSS-REFERENCE TO RELATED APPLICATIONS

This application hereby claims priority to and the benefit of U.S. Provisional Application Ser. No. 63/161,602, entitled “SYSTEMS AND METHODS FOR ONBOARD DIMENSIONING,” filed Mar. 16, 2021. U.S. Provisional Application Ser. No. 63/161,602 is hereby incorporated by reference in its entireties for all purposes.

### BACKGROUND

Vehicles such as lift trucks can be configured to support loads of varying sizes and shapes. For example, a lift truck may transport an object within a warehouse or other area. However, issues exist with carriage or loading of different objects, such as complications with securing and/or arranging multiple objects of different shapes on the lift truck and/or in a storage area.

Accordingly, there is a need for an onboard dimensioning system that determines a shape of a loaded object.

### SUMMARY

Disclosed is an onboard object dimensioning system for a vehicle, such as a lift truck. The vehicle may have one or more sensors (e.g., a radar system, an acoustic sensor, an image capture system, LIDAR, microwave, etc.) to generate and transmit a signal toward an object on the vehicle, which is received as a feedback signal corresponding to a reflection from one or more surfaces of the object. Control circuitry receives data from the sensors including signal characteristics of the feedback signal. The data is converted into multiple dimensions corresponding to the one or more surfaces of the object, which are employed to determine a shape, volume, orientation, or area of the one or more surfaces of the object corresponding to the first and second dimensions.

These and other features and advantages of the present invention will be apparent from the following detailed description, in conjunction with the appended claims.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1A is a diagrammatic illustration of an example object dimensioning system for a vehicle, in accordance with aspects of this disclosure.

FIG. 1B is a diagrammatic illustration of the example object dimensioning system for a vehicle of FIG. 1A with a loaded object, in accordance with aspects of this disclosure.

FIG. 1C is a diagrammatic illustration of the example object dimensioning system for a vehicle of FIG. 1A with the loaded object, in accordance with aspects of this disclosure.

FIG. 2 illustrates a perspective view of another example object dimensioning system for a vehicle, in accordance with aspects of this disclosure.

FIG. 3 illustrates an example flow chart of implementing an object dimensioning system for a vehicle, in accordance with aspects of this disclosure.

FIG. 4 is a diagrammatic illustration of an example control circuitry, in accordance with aspects of this disclosure.

The figures are not necessarily to scale. Where appropriate, similar or identical reference numbers are used to refer to similar or identical components.

### DETAILED DESCRIPTION

The present disclosure describes an object dimensioning system for a vehicle, such as a lift truck. In particular, the vehicle may have a sensor (e.g., a radar system, an acoustic sensor, an image capture system, LIDAR, microwave, etc.) to generate and transmit a signal toward an object on the vehicle, which is received as a feedback signal corresponding to a reflection from one or more surfaces of the object. Control circuitry receives data from the sensor including signal characteristics of the feedback signal. The data is converted into multiple dimensions (e.g., a length, a wide, an angle, a relative position, a distance, etc.) corresponding to the one or more surfaces of the object, which are employed to determine a shape, volume, orientation, or area of the one or more surfaces of the object corresponding to the first and second dimensions.

Based on the data, a shape, volume, orientation, or area of the object is calculated or estimated based on the determined shape, volume, orientation, or area of the one or more surfaces.

In some examples, dimensions of the object are determined based on a calculation, estimation, and/or determination of one or more endpoints of each of the surfaces. For example, the endpoints may correspond to portions of the surfaces that extend farthest in any given direction. The system determines a location of a greatest endpoint in one or more axes. At the endpoints, a plane can be generated (e.g., in a digital model) corresponding to each of six sides of a cuboid based defined by the endpoint that extends the greatest distance at each side. Based on the location of the endpoints and corresponding plane, a shape, volume, orientation, or area of the cuboid can be created, such as in a digital model, image, etc.

Palletized freight and non-palletized freight, carried on a vehicle such as a forklift truck, can have uneven shapes and/or protrusions resulting in uneven surfaces. Moreover, these uneven surfaces take up space in a trailer. However, for many vehicles, surfaces of such objects may be hidden from vision based sensors mounted on a forklift truck, for example. To overcome such restrictions, conventional systems have employed complicated sensors and/or routines, challenging efficiencies for storage and/or transport of freight, as those systems employ stationary measuring equipment located in dedicated areas, requiring vehicles to travel to such areas for dimensioning.

The disclosed example onboard dimensioning system provides advantages over conventional object measurement systems. For example, an onboard dimensioning system allows for optimization of space, movement, and/or timing based on sensing and/or dimensioning technologies. Conventional systems employ stationary sensors (e.g., mounted to a wall, ceiling, or other structure) focused on a limited area, which requires the object to be brought to the specific location and remain static during a measurement process.

By contrast, the disclosed onboard dimensioning system is configured to track the object and/or vehicle, and capture data corresponding to one or more of dimensions, shape, volume, orientation, or area of the object, whether the object is stationary or in motion. Further, the sensors are configured to capture object data from multiple perspectives, such that a composite model and/or image can be created from each perspective.

Accordingly, the disclosed examples provide an onboard dimensioning system with increased flexibility and applicability, while allowing for movement of object. As a result, warehousing and/or loading of freight or other objects may realize increase efficiencies, such as a reduction of transport routes and optimization of trailer space.

Further, by expanding the amount and/or type of objects available for dimensioning (without requiring dimensioning in a single, static location), errors associated with estimating the size and/or shape of the objects can be reduced or eliminated. As a result, placement in storage and/or transport containers can be optimized to remove or eliminate valuable unused space. Moreover, as object tracking and/or transport billing is often tied to object size (and the amount of space needed for such storage and/or transport), the ability to more readily and/or more accurately determine object dimensions increases the availability and/or accuracy of sales and/or billing.

When introducing elements of various embodiments described below, the articles “a,” “an,” and “the” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed subject matter, it will be appreciated that these examples are illustrative in nature and that the term “exemplary” is not used herein to denote any preference or requirement with respect to a disclosed aspect or embodiment. Additionally, it should be understood that references to “one embodiment,” “an embodiment,” “some embodiments,” and the like are not intended to be interpreted as excluding the existence of additional embodiments that also incorporate the disclosed features.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein, the terms “first” and “second” may be used to enumerate different components or elements of the same type, and do not necessarily imply any particular order.

As used herein the terms “circuits” and “circuitry” refer to any analog and/or digital components, power and/or control elements, such as a microprocessor, digital signal processor (DSP), software, and the like, discrete and/or integrated components, or portions and/or combinations thereof, including physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

The terms “control circuit,” “control circuitry,” and/or “controller,” as used herein, may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards that form part or all of a controller.

In the drawings, similar features are denoted by the same reference signs throughout.

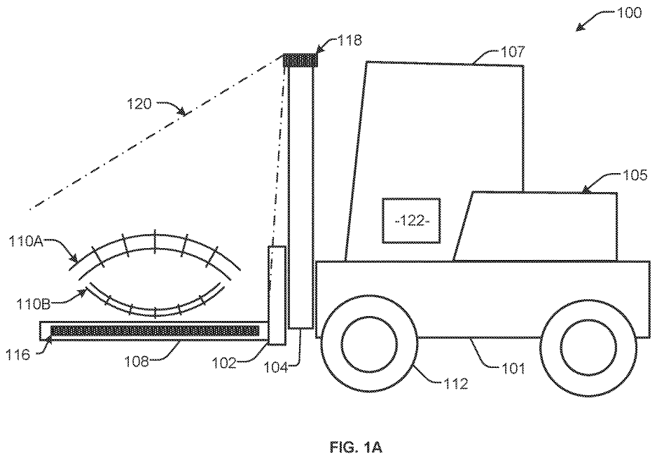

Turning now to the drawings, FIGS. 1A to 1C illustrate a partial underbody (e.g., bottom) view of example onboard dimensioning system 100, in accordance with aspects of this disclosure. In the example of FIG. 1A, the system 100 is incorporated with a vehicle 105, which includes one or more of a lift truck carriage 104, a lift truck carriage mount 102, and one or more forks or load handling fixtures 108 to support and/or manipulate a load. A chassis 101 supports the vehicle components via one or more wheels 112. An operator can command the lift truck attachment system 100 to perform an object dimensioning operation, while controlling the system to raise, lower, and/or manipulate the object, freight, and/or load (e.g., object 103 of FIGS. 1B and 1C).

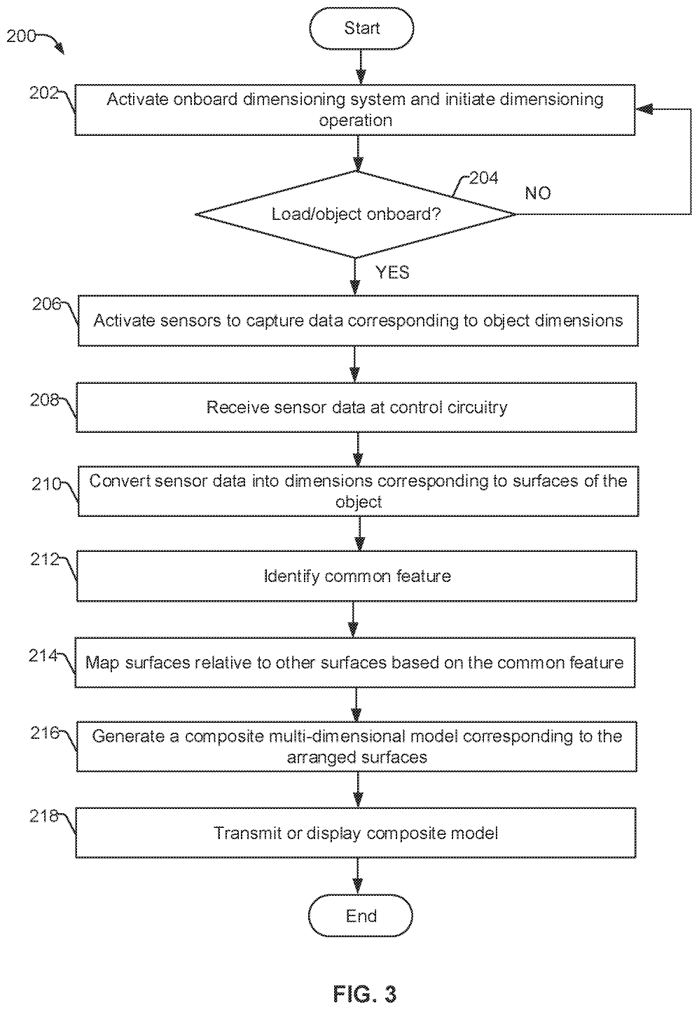

In some examples, a control circuitry or system 122 is included and configured to control one or more components of the system to implement one or more of monitoring, measuring, analyzing, and/or generating an output corresponding to a dimensioning operation. The control circuitry 122 may contain a processor 150, memory storage device 156, one or more interfaces 154, a communications transceiver 152, an energy storage device 160, and/or other circuitry (e.g., control system 164) to control the system 100 (see, e.g., FIG. 4). In some examples, the system 100 is powered by one or more of batteries, an engine, solar or hydrogen cell, and/or mains power, as a non-limiting list of examples. In some examples, one or more of the system components (e.g., sensors 116, 118) are provided power via electrical conductors and/or wireless power coupling (e.g., inductive power transmission).

The system 100 can include one or more sensors configured to sense, monitor, and/or measure one or more dimensions of the object 103. As shown in the example of FIG. 1A, a first sensor 116 is arranged, embedded, incorporated, or otherwise associated with load handling fixtures 108. A second sensor 118 is arranged, embedded, incorporated, or otherwise associated with the mast 104. Although illustrated in example FIG. 1A as being located in particular positions on the vehicle 105, one or both of the sensors 116, 118 may be arranged on another structures of the vehicle, such as the carriage 102, the chassis 101, the cab 107, as a list of non-limiting examples. Further, although illustrated as including two sensors 116, 118, each sensor may comprise two or more sensors, one or more additional sensors may be added, or a single sensor may be employed. Moreover, a dimensioning operation may incorporate data from sensors external to the system 100. Example sensors can include one or more of a radar system, an acoustic sensor, an image capture system, a laser based system, an acoustic sensor, a light detection and ranging (LIDAR) system, a microwave system, etc.

In some examples, the sensor 116 is a radar or acoustic sensor arranged within the load handling fixtures 108. When activated, the sensor 116 generates signal(s) 110A, which result in one or more feedback signal(s) 110B following reflection from an object. Example signal(s) 110A may include a point cloud, ranging signal, 3D scanning laser, single and/or multi-wavelength electromagnetic waves (e.g., visible light, infrared light, microwaves, etc.), and/or any other signals. In this manner, the sensor 116 captures data corresponding to dimensions of the object without the need for line-of-sight imaging.

Example sensor 118 is an image capture device, such as a vision based camera, infrared camera, or a laser detector, as a list of non-limiting examples. Sensor 118 is configured to capture data within a field of view, represented by lines 120.

Conventional systems consist of cameras, lasers or other sensors that are mounted stationary to a wall, ceiling or a table. By contrast, the example system 100 allows for vehicle mounted sensors and a mobile implementation.

During a dimensioning operation, one or more of the sensors 116, 118 are activated, capturing measurements and/or data associated with one or more dimensions (e.g., length, width, angle, etc.) of one or more surfaces of the object 103. The data corresponding to the dimensions measurement (and/or location of the respective sensor) are transmitted (via wired and/or wireless communications) to the control circuitry 122 for analysis.

The control circuitry 122 may be configured to receive data (e.g., dimensions, measurements) from the sensors 116, 118, such as by a digital and/or analog data signal. The control circuitry 122 is configured to calculate, estimate, and/or otherwise determine one or more dimensions (e.g., shape, volume, orientation, size, area, etc.) of one or more surfaces of the object 103 based on the data. Once dimensions of the object surfaces have been determined, the control circuitry 122 is further configured to calculate, estimate, and/or otherwise determine one or more dimensions (e.g., shape, volume, orientation, size, area, etc.) of the object based on the determined of the one or more surfaces.

A dimensioning operation may be performed while the vehicle 105 is stopped, having secured a load 103, and/or while the vehicle 105 is in motion. The system 100 can continually or periodically update the sensor data, such as during a loading or unloading operation, and/or in response to an operator command.

The control circuitry 122 may be configured to generate an alert signal in response to a particular determination, such as a volume of the object 103 exceeds one or more threshold values (e.g., length, width, shape, etc.). The alert may be transmitted to an operator facing device (e.g., a user interface, a remote computer or controller, etc.) which provides an indication of the determination. In some examples, threshold values and/or distribution plan data 158 are stored in the memory storage device 156, accessible to the processor 150 for analysis.

In some examples, devices and/or components (not shown) may be connected to provide signals corresponding to the output from the sensors 116, 118 for analysis, display, and/or recordation, for instance.

Although some examples are represented as fork lift trucks, the concepts disclosed herein are generally applicable to a variety of vehicles (e.g., lorries, carts, etc.) and/or lift modalities (e.g., “walkie stackers,” pallet jacks, etc.) to determine dimensions of a load.

Turning now to FIG. 1B, a load 103 is arranged on the load handling fixtures 108, the load 103 including a first object 103A with a first set of dimensions and a second object 103B with a second set of dimensions. The sensors 116 and 118 have been activated to perform a dimensioning operation. In the example of FIG. 1B, sensor 116 is a radar, and radio waves 110A are transmitted toward the load 103 via sensor 116 (e.g., a transmitter and/or transceiver). Feedback wave 110B is reflected back to the sensor 116 (e.g., an antenna and/or transceiver) from surfaces 114E and 114F with a plurality of signal characteristics corresponding to the dimensions. The plurality of signal characteristics may include one or more of a frequency, a signal strength, signal time of flight, Doppler shift, angle of arrival, signal polarization, or a change thereof, for instance. Data collected by the sensor 116 indicates the first object 103A has a surface with a first set of dimensions, and second object 103B has a second set of dimensions. For example, the sensor 116 data indicates objects 103A and 103B share a common right side at surface 114D, whereas surfaces 114A and 114B are not aligned.

In an example employing a radar enabled sensor, the data may include a plurality of signal characteristics corresponding to dimensions of the surfaces, such as a frequency, a signal strength, signal time of flight, Doppler shift, angle of arrival, signal polarization, or a change thereof. Data processing (e.g., at the control circuitry 122 and/or the processor 150) will provide compensation for time, movement, angular orientation, extrapolation of surface dimensions, via one or more algorithms to calculate, estimate, and/or determine the dimensions of the object 103. Further, the antenna or transceiver of the sensor 116 can be tuned to ensure the data collected is limited to object dimensions rather than environmental features (e.g., walls, pillars, other vehicles, objects, etc.).

Sensor 118 captures image, laser, and/or other data from another perspective, providing another set of dimensioning data. For example, surface 114C is fully imaged, surface 114D is partially or completely imaged, whereas surfaces 114A, 114B, 114E and 114F are partially or completely obscured. The control circuitry 122 is configured to generate a model representing a composite of available data, such as by compiling and arranging the surfaces to form the model. The data can be compiled with reference to one or more parameters, including time, a common reference (e.g., identifiable structural feature of the object, fiducial marker, watermark, etc.), and/or a known dimension of a surrounding feature (e.g., the load handling fixtures), as a list of non-limiting examples.

Although FIGS. 1A to 1C provide an example side perspective of the system 100 and object 103, the sensing technologies and/or dimensioning operation may be implemented to measure multiple surfaces and/or perspectives relative to the object 103.

FIG. 1C illustrates the object 103 following a dimensioning operation. For example, the model generated via the collected data is shown as a virtual cuboid 124 with dimensions 124A and 124B. The dimensions of the cuboid 124 reflect the longest endpoints along each axis (e.g., along six sides of the cube). The dimensions of the cuboid model 124 can be transmitted to a remote system (e.g., remote computer 166 of FIG. 4), which may be used to calculate arrangement for storage of freight in a warehouse, container, vehicle, etc.

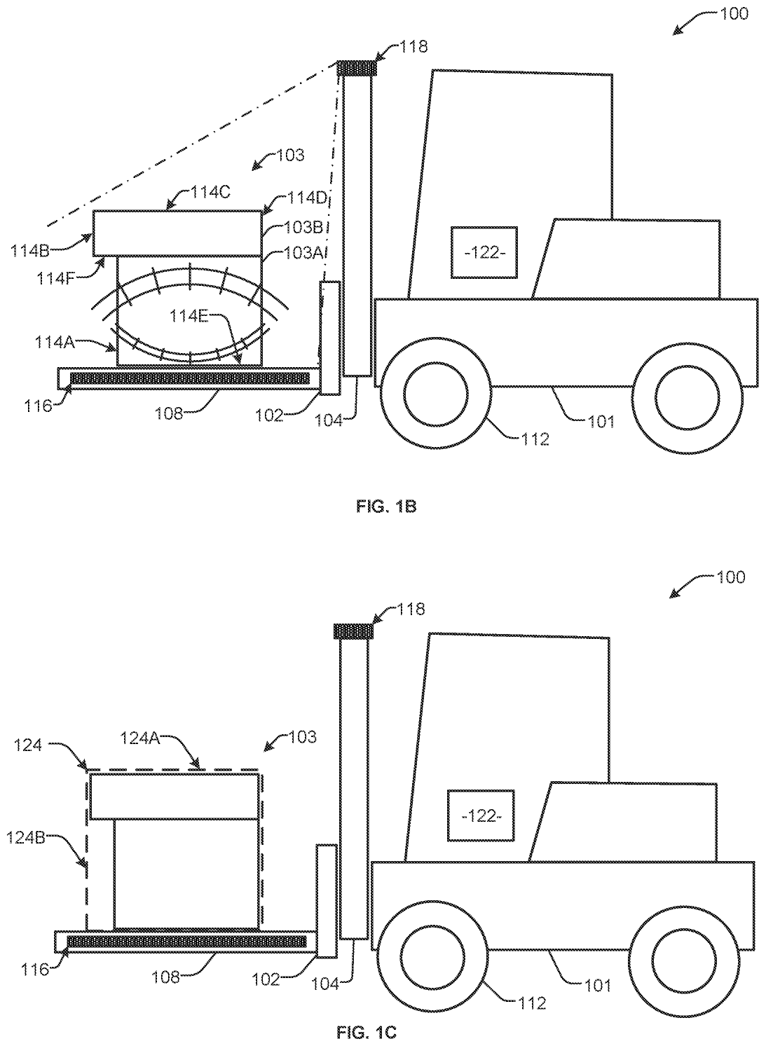

As shown in the example of FIG. 2, sensors 116 and/or 118 can be arranged in a variety of vehicles, such as truck 200. The sensors 116 and/or 118 are arranged to capture data corresponding to object dimensions, such as during a loading or unloading operation.

In some examples, sensors (e.g., similar to sensors 116 and/or 118) can be employed in an area, such as warehouse environments. A similar object dimensioning operation can be implemented in such an area.

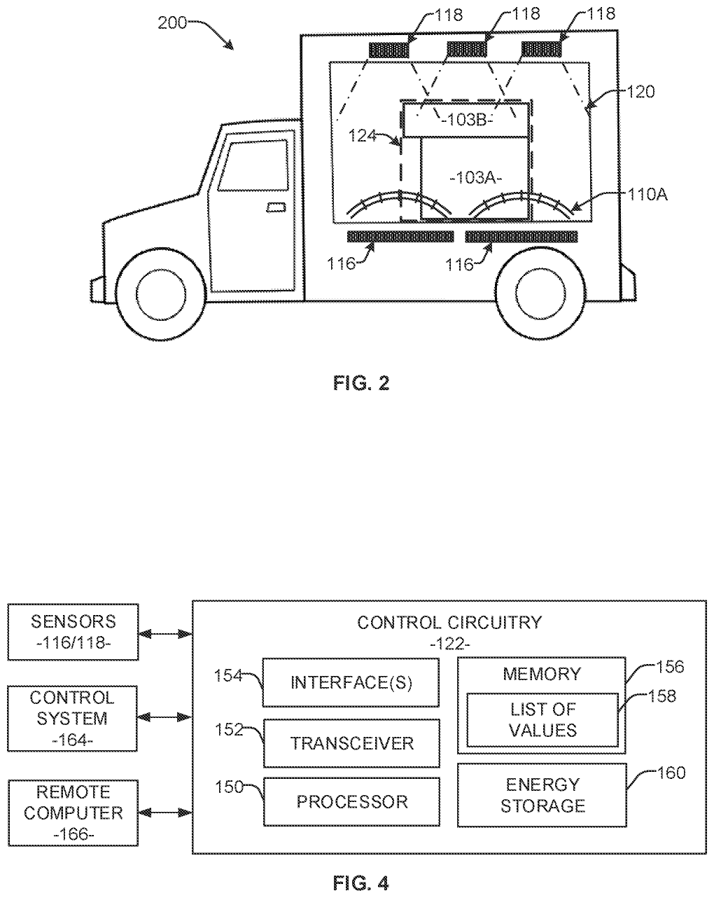

FIG. 3 is a flowchart representative of the program 200. For example, the program 200 may be stored on a memory (e.g., memory circuitry 156) linked to processor (e.g., processor 150) as a set of instructions to implement an onboard dimensioning operation via associated circuitry (e.g., control circuitry 122), as disclosed herein.

At block 202, the program 200 activates an onboard dimension system and initiates a dimensioning operation, such as in response to a user input (e.g., a command to initiate the operation), a sensor input (e.g., a motion and/or weight sensor), etc. At block 204, the program determines whether a load or object is onboard a vehicle. If no object is present, the program returns to block 202 and awaits instructions to proceed. If an object is present (such as verified by a motion and/or weight sensor), the program proceeds to block 206, where one or more sensors (e.g., sensors 116 and/or 118) are activated to capture data corresponding to one or more dimensions of the object.

At block 208, the sensor data is transmitted from the sensors and received at the control circuitry, where it is converted into dimensions corresponding to surfaces of the object in block 210. At block 212, one or more common features of the object are identified. For example, the sensor data (from one or more sensors) may include the common feature (e.g., a structural feature—such as a physical endpoint—measured during data capture, a measurable indicator such as a digital code or watermark, etc.), which can be used to map the surfaces from multiple views and/or sensors to generate a composite multi-dimensional model in block 216.

In some examples, the composite model is generated as a cuboid model, with one more dimensions of the top-most portion or surface measured by the sensor 118, with one more dimensions of the lower portion measured by the sensor 116. In particular, measurements from the sensors are stitched together, such as by reference to the common identifying feature. In some examples, an algorithm is applied to identify starts, stops, and/or voids of the surfaces, and/or to extrapolate to solidify the cuboidal model.

In some examples, the dimensions of the cuboid can be estimated to the nearest maximum dimension that is captured by the sensors and/or dimensioned by the control circuitry. For example, the control circuitry can determine endpoints of each of the one or more surfaces. The location of a greatest endpoint in one or more axes can be identified and used to generate a plane corresponding to each of six sides of a cuboid based on each greatest endpoint. The location and extent of the endpoints are then used to estimate a shape, volume, orientation, or area of the cuboid comprising the planes corresponding to each of the six axes

As a composite model may incorporate several data sets, images, and/or perspectives, one or more of the surfaces may be used to build multiple models. As one or more of the models may lack detail (based on an estimated surface dimension), multiple models may be compiled to generate the composite model representing a best estimate of the objects dimensions. In some examples, when multiple surfaces (e.g., from multiple views and/or sensors) present conflicting surface dimensions, the dimension is used to estimate the shape, volume, orientation, or area of the object. This technique can be applied to each of six sides of the cuboid to generate the model.

In some examples, the object may be transported on a support or surface (such as a pallet), which can be used as additional data for generating a composite model. At block 218, the composite model can be transmitted to another system (e.g., remote computer 166) or presented to a user (e.g., via interface 154). The program may end, continue in a loop, and/or activate periodically to initiate a dimensioning operation.

In some examples the sensors 116, 118 operate in concert (e.g., the respective sensors are employed simultaneously, in turn, and/or measure a common surface and/or feature), such that measurements from each sensor may be provided to the processor 150 to calculate an accurate dimensions and/or a volume of the object 103.

As provided herein, sensor data corresponding to object dimensions is provided to the control circuitry 122 and/or another computing platform (e.g., remote computer or system 166) for analysis, display, recordation, display, etc. As shown in the example of FIG. 4, a processor 150 can be configured to receive and translate information from the one or more sensors 116, 118 into a digital and/or computer readable format, for analysis (e.g., via processor 150), display to an operator (e.g., via an interface 154), to store in memory (e.g., memory storage device 156), and/or transmission to another computing platform 166, such as a remote computer and/or central repository. In some examples, the sensors 116, 118 may include a wired and/or wireless transceiver to transmit information to another device for processing. The processor 150 that receives the output is capable of determining dimensions of one or more surfaces of the object base on sensor data received from the sensors 116, 118. The control circuitry 122 and/or the processor 150 is capable of executing computer readable instructions, and may be a general-purpose computer, a laptop computer, a tablet computer, a mobile device, a server, and/or any other type of computing device integrated or remote to the system 100. In some examples, the control circuitry 122 is implemented in a cloud computing environment, on one or more physical machines, and/or on one or more virtual machines.

In examples, sensors 116 and 118 are one or more of a radar system, an acoustic sensor, an image capture system, a laser based system, an acoustic sensor, a LIDAR system, or a microwave system, but can be some other type of sensor that provides desired sensitivity and accuracy. For example, the sensor(s) 116, 118 are configured to generate a signal representative of the object dimensions during a measuring operation and transmit that signal to a device configured to receive and analyze the signal.

For example, the sensor(s) 116, 118 may be in communication with the processor 150 and/or other device to generate an output associated with a measured value (e.g., for display, to provide an audible alert, for transmission to a remote computing platform, for storage in a medium, etc.). The processor 150 is configured to parse analog or digital signals from the one or more sensors in order to generate the signal.

In some examples, the control circuitry is configured to compare the plurality of signal characteristics to a list associating signal characteristics to object dimensions, which can be used to calculate or estimate dimensions of the object. The control circuitry can additionally or alternatively compare the first or second dimensions to a list associating dimensions to one or more of a shape, a volume, an orientation, or an area of an object to calculate or estimate one or more dimensions of the object.

Generally, any number or variety of processing tools may be used, including hard electrical wiring, electrical circuitry, transistor circuitry, including semiconductors and the like.

In some examples, the memory storage device 156 may consist of one or more types of permanent and temporary data storage, such as for providing the analysis on sensor data and/or for system calibration. The memory 156 can be configured to store calibration parameters for a variety of parameters, such as sensor type, type of load, type of vehicle, and/or presence or absence of a load. The historical measurement data can correspond to, for example, operational parameters, sensor data, a user input, as well as data related to trend analysis, threshold values, profiles associated with a particular measurement process, etc., and can be stored in a comparison chart, list, library, etc., accessible to the processor 150. The output from the processor 150 can be displayed graphically, such as the current dimension measurements, as a historical comparison, for instance. This process can be implemented to calibrate the system 100 (e.g., prior to implementing a dimensioning operation).

The present method and/or system may be realized in hardware, software, or a combination of hardware and software. The present methods and/or systems may be realized in a centralized fashion in at least one computing system, or in a distributed fashion where different elements are spread across several interconnected computing or cloud systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

As utilized herein, the terms “e.g.,” and “for example” set off lists of one or more non-limiting examples, instances, or illustrations.

What is claimed is:

1. An object dimensioning system for a vehicle comprising:
a sensor configured to:
generate and transmit a signal toward an object on the vehicle; and
receive a feedback signal corresponding to a reflection of the signal from one or more surfaces of the object; and
control circuitry configured to:
receive data from the sensor comprising one or more signal characteristics of the feedback signal;
convert the data into dimensions corresponding to the one or more surfaces of the object; and
determine a shape, volume, orientation, or area of the one or more surfaces of the object corresponding to the first and second dimensions.

2. The object dimensioning system of claim 1, wherein the control circuitry is further configured to calculate or estimate a shape, volume, orientation, or area of the object based on the determined shape, volume, orientation, or area of the one or more surfaces.

3. The object dimensioning system of claim 2, wherein the control circuitry is further configured to:
determine endpoints of each of the one or more surfaces;
determine a location of a greatest endpoint in one or more axes;
generate a plane corresponding to each of six sides of a cuboid based on each greatest endpoint; and
estimate a shape, volume, orientation, or area of the cuboid comprising the planes corresponding to each of the six sides.

4. An object dimensioning system for a lift truck comprising:
a radar system comprising:
a signal transmitter to generate a plurality of radio signals and transmit the plurality of radio signals toward an object loaded onto the lift truck; and
an antenna to receive a plurality of feedback radio signals corresponding to a reflection of the plurality of radio signals from one or more surfaces of the object; and
control circuitry configured to:
receive data from the radar system comprising a plurality of signal characteristics corresponding to the plurality of feedback radio signals; and
determine one or more dimensions of the one or more surfaces of the object based on the plurality of signal characteristics corresponding to the data.

5. The object dimensioning system of claim 4, wherein the plurality of signal characteristics comprise one or more of a frequency, a signal strength, signal time of flight, Doppler shift, angle of arrival, signal polarization, or a change thereof.

6. The object dimensioning system of claim 4, wherein the antenna is arranged on one or more load handling fixtures mounted to the lift truck.

7. The object dimensioning system of claim 4, wherein the signal generator is a first signal generator and the antenna is a first antenna, the radar system further comprising a second signal generator and a second antenna.

8. The object dimensioning system of claim 4, wherein the first antenna is arranged at a first location of the lift truck, and the second antenna is arranged at a second location of the lift truck.

9. The object dimensioning system of claim 5, wherein the first location corresponds to a lift truck carriage of the lift truck, and the second location corresponds to a cab of the lift truck.

10. The object dimensioning system of claim 4, wherein the control circuitry is further configured to:
convert the plurality of signal characteristics into one or more measurements corresponding to the one or more surfaces of the object;
calculate the one or more dimensions of the one or more surfaces of the object based on the one or more measurements; and
calculate or estimate a shape, volume, orientation, or area of the object based on the calculated one or more dimensions of the one or more surfaces.

11. An object dimensioning system for a lift truck comprising:
a first sensor arranged on the lift truck and configured to measure a first characteristic of the object;
a second sensor arranged on the lift truck and configured to measure a second characteristic of the object; and
control circuitry configured to:
receive first and second measurements corresponding to the first and second characteristics, respectively;
convert the first and second measurements into first and second dimensions, respectively, corresponding to one or more surfaces of the object; and
determine a shape, volume, orientation, or area of the one or more surfaces of the object corresponding to the first and second dimensions.

12. The object dimensioning system of claim 11, wherein the control circuitry is further configured to calculate or estimate a shape, volume, orientation, or area of the object based on the determined shape, volume, orientation, or area of the one or more surfaces.

13. The object dimensioning system of claim 11, wherein the control circuitry is further configured to compare the first or second characteristics to a list associating signal characteristics to object dimensions to calculate or estimate one or more dimensions of the object.

14. The object dimensioning system of claim 11, wherein the control circuitry is further configured to compare the first or second dimensions to a list associating dimensions to one or more of a shape, a volume, an orientation, or an area of an object to calculate or estimate one or more dimensions of the object.

15. The object dimensioning system of claim 11, wherein the first sensor is arranged at a first location on the lift truck, and the second sensor is arranged at a second location on the lift truck.

16. The object dimensioning system of claim 11, wherein the control circuitry is further configured to transmit one or more of dimensions, shape, volume, orientation, or area of the object to a remote computing system.

17. The object dimensioning system of claim 11, wherein the first or second sensor comprises one or more of a radar system, an acoustic sensor, an image capture system, a laser based system, an acoustic sensor, a LIDAR system, a microwave system, or a combination thereof.

18. The object dimensioning system of claim 11, wherein the antenna is embedded within a load handling fixture.

19. The object dimensioning system of claim 11, wherein the first location corresponds to a lift truck carriage of the lift truck, and the second location corresponds to a cab of the lift truck.

20. The object dimensioning system of claim 11, wherein the control circuitry is further configured to:
calculate or estimate a first shape, volume, orientation, or area of the object based on the first measurements;
calculate or estimate a second shape, volume, orientation, or area of the object based on the second measurements;
map the first shape, volume, orientation, or area of the object to the second shape, volume, orientation, or area of the object; and
generate a composite shape, volume, orientation, or area of the object based on the first and second measurements.
